(19) United States
(12) Patent Application Publication
(10) Pub. No.: US 2016/0373972 A1
(43) Pub. Date: Dec. 22, 2016

(54) Network Nodes and Methods Therein for Handover for Dual Connectivity

(71) Applicant: TELEFONAKTIEBOLAGET LM ERICSSON (PUBL), Stockholm (SE)

(72) Inventors: Alexander Vesely, Feldbach (AT); Mojgan Fadaki, Solna (SE); Walter Müller, Upplands Väsby (SE)

(21) Appl. No.: 14/904,163

(22) PCT Filed: Nov. 30, 2015
(86) PCT No.: PCT/SE2015/051285

§ 371 Date: Jan. 11, 2016

Related U.S. Application Data
(60) Provisional application No. 62/109,876, filed on Jan. 30, 2015.

(51) Int. Cl. H04W 36/00

(52) U.S. Cl. CPC H04W 36/0027; H04W 36/0033; H04W 76/025

(57) ABSTRACT

Network nodes and methods therein are provided for Master eNB-handover of a UE in Dual Connectivity. A provided method to be performed by a network node operable to be a Target MeNB for the UE comprises receiving a request for handover of a UE in Dual Connectivity from a Source MeNB to the Target MeNB, where the request comprises information about the UE Context of the UE at a Secondary eNB, SeNB. The method further comprises establish a signaling connection with the SeNB based on the information about a UE Context. Thereby, an inter-MeNB without change of SeNB is enabled in an efficient manner.

### TECHNICAL FIELD

The embodiments of the solution disclosed herein relates to handover (HO) of wireless devices in wireless communication networks, and in particular to handling of handover of a wireless device in Dual Connectivity.

### BACKGROUND

A new approach for increasing mobile network capacity and performance is to use heterogeneous networks where the traditional pre-planned macro base stations, also known as the macro layer, are complemented with several low-powered base stations that may be deployed in a relatively unplanned manner. The 3^{rd} Generation Partnership Project (3GPP) has incorporated the concept of heterogeneous networks as one of the core items of study in the latest enhancements of Long Term Evolution (LTE), such as LTE Release (Rel) 11. Several low-powered base stations for realizing heterogeneous networks, such as pico base stations, femto base stations, also known as home base stations or HeNBs, relays, and Remote Radio Heads (RRHs), have been defined.

Dual Connectivity was introduced in LTE Rel-12 for inter frequency heterogeneous deployments, i.e. where macro and pico base stations operate on separate frequencies.

Dual Connectivity is a feature defined from a wireless device or User Equipment (UE) perspective wherein the UE may simultaneously receive from and may transmit to at least two different network points. Dual Connectivity is one of the features that are being standardized within an umbrella work of small cell enhancements within 3GPP. A UE in Dual Connectivity maintains simultaneous connections to Master eNB (MeNB) and Secondary eNB (SeNB) nodes, see FIG. 1. As the name indicates, the MeNB terminates the control plane connection towards the UE and is thus the controlling node of the UE. (The radio protocol architecture for LTE can be separated into control plane architecture and user plane architecture, where the control plane is related to control operations such as network attaches, security control, authentication, setting up of bearers, and mobility management.) The MeNB may also be denoted e.g. the anchor point or the anchor node of the UE. In addition to the MeNB, a UE in Dual Connectivity is also connected to an SeNB for added user plane support. At least currently, the assumption in 3GPP is that a UE can only connect to one other eNB (SeNB) besides the MeNB. However, this may change in future releases of the standard. The MeNB and SeNB roles are defined from a UE point of view. This means that an eNB that acts as a MeNB for one UE may act as SeNB for another UE.

However, the fact that a UE may be connected to more than one eNB at the time is a challenge from a mobility point of view.

### SUMMARY

It is desired to improve mobility aspects for a UE in Dual Connectivity. In particular, an object of embodiments described herein is to improve a handover procedure for a UE in Dual Connectivity. This is achieved by embodiments disclosed herein according to the independent claims in the appended set of claims.

The embodiments herein enable Inter-MeNB mobility in Dual Connectivity while keeping the UE context of the UE at the SeNB. The maintaining or keeping of a UE context at the SeNB enables the target MeNB to address the already established UE context at the SeNB. Thereby, a UE is enabled to continue using Secondary Cell Group (SCG) resources while a MeNB function, i.e. a Master Cell Group (MCG), is handed over to a target MeNB, which is highly beneficial.

According to a first aspect, a method is provided, which is to be performed by a first network node. The method comprises receiving a request for handover of a UE in Dual Connectivity from a second network node to the first network node, the request comprising information about the UE Context of the UE at a third network node, where the first network node is a Target Master eNB, T-MeNB, for the UE; the second network node is a Source MeNB, S-MeNB, for the UE and the third network node is a Secondary eNB, SeNB, for the UE. The method further comprises establishing a signaling connection with the third network node, i.e. the SeNB, based on the information about the UE Context of the UE. The method relates to inter-MeNB handover without SeNB change.

According to a second aspect, a method is provided, which is to be performed by a second network node. The method comprises requesting a handover of a UE in Dual Connectivity from the second network node to a first network node, the request comprising information about a UE Context at a third network node; the second network node being a S-MeNB for the UE; the first network node being a T-MeNB for the UE; and the third network node being a SeNB for the UE. The method further comprises receiving, from the first network node, i.e. the T-MeNB, an acknowledgement of the request, indicating that a signaling connection has been established between the first network node, i.e. the T-MeNB, and the third network node, i.e. the SeNB, based on the information about the UE Context. The method further comprises indicating, to the third network node, i.e. the SeNB, a release of a signaling connection between the third network node, i.e. the SeNB, and the second network node, i.e. the S-MeNB. The method relates to inter-MeNB handover without SeNB change.

According to a third aspect, a first network node is provided, which is operable in a wireless communication network. The first network node is configured to receive a request for a handover of a UE in Dual Connectivity from a second network node to the first network node, the request comprising information about the UE Context of the UE at a third network node. The first network node is operable to be a T-MeNB for the UE; the second network node is a S-MeNB for the UE, and the third network node is a SeNB, for the UE. The first network node is further configured to establish a signaling connection with the third network node, being a SeNB for the UE, based on the information about the UE Context of the UE.

According to a fourth aspect, a second network node is provided, which is operable in a wireless communication network. The second network node is configured to request a handover of a UE in Dual Connectivity to a first network node, the request comprising information about the UE Context of the UE at a third network node. The second network node is operable to be a S-MeNB for the UE; the first network node is a T-MeNB for the UE; and the third network node is a SeNB for the UE. The second network node is further configured to receive, from the first network node, i.e. the T-MeNB, an acknowledgement of the request, indicating that a signaling connection has been established between the first network node, i.e. the T-MeNB, and the third network node, i.e. the SeNB, based on the information about the UE Context of the UE. The second network node is further configured to indicate, to the third network node, i.e. the SeNB, a release of a signaling connection between the third network node, i.e. the SeNB, and the second network node, when being an S-MeNB for the UE.

According to a fifth aspect, a computer program is provided, which comprises instructions which, when executed on at least one processor, cause the at least one processor to carry out the method according to the first or second aspect.

According to a sixth aspect, a carrier is provided, containing the computer program of the fifth aspect, wherein the carrier is one of an electronic signal, optical signal, radio signal, or computer readable storage medium.

### BRIEF DESCRIPTION OF DRAWINGS

The foregoing and other objects, features, and advantages of the technology disclosed herein will be apparent from the following more particular description of embodiments as illustrated in the accompanying drawings. The drawings are not necessarily to scale, emphasis instead being placed upon illustrating the principles of the technology disclosed herein.

FIG. 1 illustrates Dual Connectivity according to the prior art.

FIG. 2 illustrates a MeNB handover of a UE in Dual Connectivity, i.e. a scenario where embodiments may be applied.

FIG. 3 is a flow chart, showing a method performed by a first network node according to an exemplifying embodiment.

FIG. 4 is a flow chart, showing a method performed by a second network node according to an exemplifying embodiment.

FIG. 5 is a signaling diagram exemplifying signaling between nodes during an inter-MeNB handover procedure without SeNB change, for a UE in Dual Connectivity, according to an exemplifying embodiment.

FIG. 6 is a flow chart, showing a method performed by a communication network according to an exemplifying embodiment.

FIGS. 7a-c illustrate different implementations of a first network nodes according to exemplifying embodiments.

FIGS. 8a-c illustrate different implementations of a second network nodes according to exemplifying embodiments.

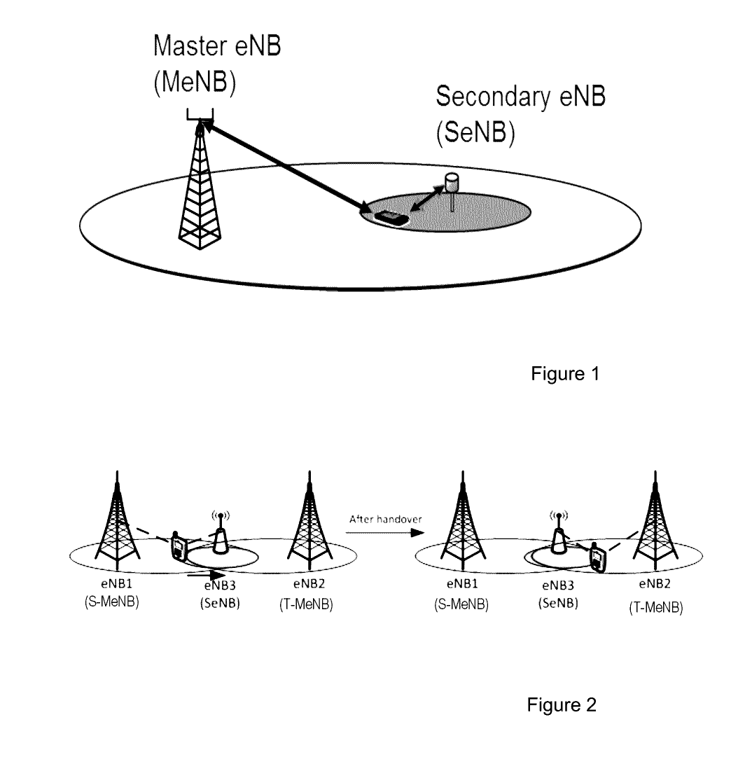

### DETAILED DESCRIPTION

When applying Dual Connectivity, a wireless device may be connected to a MeNB and a SeNB. According to the prior art, when a handover is needed, the resources used for communication between the wireless device and the SeNB first need to be switched over to the MeNB, since the MeNB controls the wireless device, as previously mentioned.

The inventors have realized that as a wireless device in Dual Connectivity moves, there may be situations where a handover is needed in relation to one of the eNBs to which the wireless device is connected, but not in relation to the other. The inventors have further realized that in the current procedure for Dual Connectivity (3GPP LTE Rel-12), there is no procedure defined for support of inter-MeNB handover without the necessity to first switch back SeNB resources to MeNB, even if the SeNB resources could be kept. Therefore, a new concept for such situations would be beneficial, which enables an inter MeNB-handover where the connection to the SeNB is maintained during and after the inter MeNB-handover. The inventors have realized that a new X2 signaling connection needs to be established from the Target MeNB to the SeNB, allowing the UE to continue using Secondary Cell Group (SCG) resources while the MeNB function is handed over to the target MeNB.

Herein, a mechanism is described, by which the UE/wireless device is enabled to continue using SCG resources while the MeNB function is handed over to a target MeNB.

Within the context of this disclosure, the terms “UE” “wireless device” and “wireless terminal” encompasses any type of wireless node which is able to communicate with a network node, such as a base station, or with another wireless device by transmitting and/or receiving wireless signals. Thus, the terms “UE” and “wireless device” encompasses, but is not limited to: a mobile terminal, a tablet, a smartphone, a stationary or mobile wireless device for machine-to-machine communication, an integrated or embedded wireless card, an externally plugged in wireless card, a dongle, etc. Whenever a “UE” is referred to in this disclosure, this should be understood as encompassing any wireless device as defined above. Although certain figures herein show a device being equipped with a screen, button and speaker, this is also strictly for illustrative purpose, and should not be taken to imply that such features are required to be present for the operation of any of the embodiments presented herein.

It should be appreciated that although examples herein refer to an eNB for purposes of illustration, the concepts described apply also to other wireless access points. The expression eNB as used in different versions in this disclosure is intended to encompass any type of radio base station, e.g. an eNB, NodeB, a pico or micro node, Home eNodeB or Home NodeB, or any other type of network node which is capable of wireless communication with a wireless device.

In the present disclosure, the terms MeNB for Master eNB and SeNB for Secondary eNB, are used to describe two different roles that an eNB could have towards a UE. The nodes could alternatively be denoted Main eNB and Supporting eNB. We further assume for simplicity that there is only a single SeNB, even though it may be more than one. Further, the concept of MeNB and SeNB could alternatively be referred to as anchor and assisting eNB.

The expression “network node” may refer to a wireless access point as defined above, but also encompasses other types of nodes residing in a wireless network and which are capable of communicating with one or more wireless access points either directly or indirectly, e.g. a centralized network node performing one or more specific functions. Furthermore it should be appreciated that a network node may at the same time serve as a wireless access point, and also perform one or more additional functions on behalf of other nodes or access points in the network. In some passages, network node may encompass a wireless device.

It should be noted that although terminology from 3GPP LTE has been used in this disclosure to exemplify the embodiments, this should not be seen as limiting the scope of the invention to only the aforementioned system. Other wireless systems which support contemporaneous connections with two or more wireless access points, e.g. Dual Connectivity, may also benefit from exploiting the ideas covered within this disclosure.

Some abbreviations used herein are listed at the end of this document. This document, however, may comprise other abbreviations, which are not explained here or in the text. An explanation to these abbreviations may be found in 3GPP documents, such as TS 36.423 (December 2014) and other specifications referred to therein.

### Exemplifying Embodiments

A procedure is provided for Inter-MeNB mobility in Dual Connectivity while keeping the UE context of the UE at the SeNB. This could alternatively be described as keeping the UE connection to the SeNB, while performing an inter-MeNB handover of the UE in Dual Connectivity. The mechanism enables the Target MeNB to address the already established UE context at the SeNB. A UE context is a block of information in an eNB which may comprise E-UTRAN and E-UTRA signaling and user plane resources and can be addressed by means of the UE associated X2 signaling connection established between the source MeNB and the SeNB. FIG. 2 illustrates an inter-MeNB handover without change of SeNB. In the figure to the left, a UE is connected to the RA node “eNB1”, which is the MeNB for the UE. The RA node eNB1 is the Source-MeNB for the UE, also referred to as second network node herein. The UE is further connected to an RA node “eNB3”, which is the SeNB for the UE, also referred to as third network node herein. Then, after a handover, e.g. according to an embodiment, as illustrated in the figure to the right in FIG. 2, the UE is still connected to the same SeNB (eNB3), but now has a new MeNB, namely “eNB2”, which is the Target-MeNB for the UE in the handover procedure, also referred to as first network node herein.

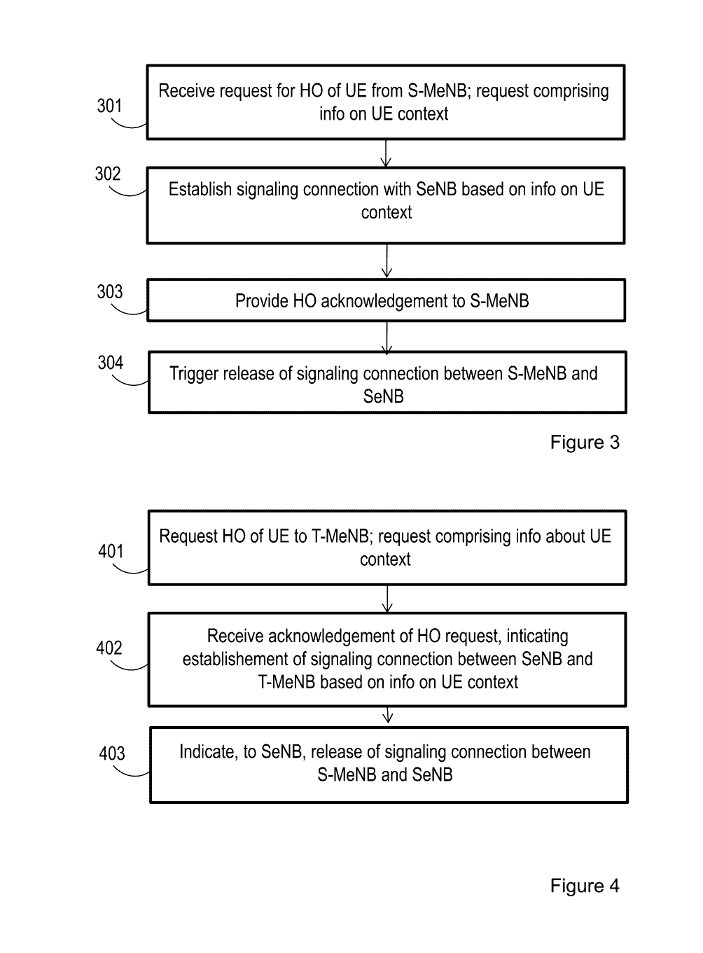

Below exemplifying method embodiments will be described with reference to FIGS. 3 and 4. First embodiments will be described from the perspective of the Target MeNB, T-MeNB, and then from the perspective of the Source MeNB, S-MeNB. FIG. 3 shows a method to be performed by a T-MeNB (denoted “first network node” e.g. in appended claims). The method is related to inter-MeNB handover of a wireless device without change of SeNB. The method comprises receiving 301 a request for handover of a UE in Dual Connectivity, from a S-MeNB (denoted “second network node” in the appended claims) to the T-MeNB. The received request comprises information about the UE Context of the UE at a SeNB (denoted “third network node” in the appended claims). The method further comprises establishing 302 a signaling connection with the SeNB based on the information about the UE Context of the UE. The method enables reuse of an already existing UE context, especially the already established resources of the UE at the SeNB, which is beneficial e.g. since setting up SCG resources anew is less efficient.

The term UE context, which is used herein and in 3GPP standard documents, such as e.g. 3GPP TS 36.300, 3GPP TS 36.401, refers to a block of information in an eNB which contains a collection of characteristics and/or information related to a UE to which a node is connected. A UE context may comprise data to operate UE-associated control signaling and user data bearers, system resources allocated to the UE, etc.

The received information about the UE Context of the UE may comprise an identifier of the SeNB, indicating in which node the UE Context is located, i.e. identifying the current SeNB to the T-MeNB. The identifier may be denoted e.g. “SeNB ID”. The information about the UE Context of the UE may further comprise an identifier of a signaling connection established between the S-MeNB node and the SeNB. This identifier may be denoted e.g. “SeNB UE X2AP”. In other words, the existing signaling connection between the S-MeNB and the SeNB may be given an identity, which may be utilized by the T-MeNB to inform the SeNB that it wants to reuse at least parts of the parameters, features or characteristics associated with the resources allocated for the particular UE at the SeNB. It may be noted, that RRC signaling is performed between the E-UTRA and the UE only via the MeNB, i.e. the UE Context at the SeNB does not contain RRC related context data. By receiving identifiers of the SeNB and the connection between the S-MeNB and the SeNB, the T-MeNB may contact the SeNB and refer to an already established UE context at the SeNB, of which parameters, features or characteristics may be reused, and thus save time and resources in the handover procedure and minimize interruption of the user data connection between towards the UE.

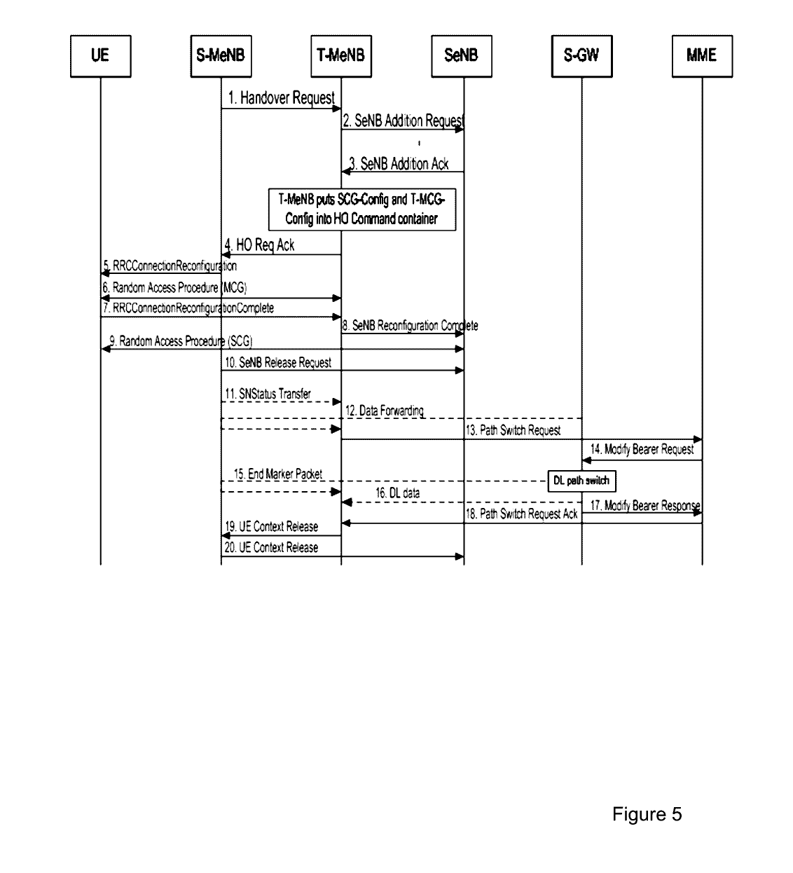

The establishing 302 of a signaling connection may comprise sending, a SeNB Addition Request to the SeNB, comprising the received information about a UE Context. The establishing 302 may further comprise receiving a SeNB Addition Acknowledgement from the SeNB in response to the request. This is also illustrated in FIG. 5, which will be described further below.

The method illustrated in FIG. 3 may further comprise providing 303 an acknowledgement of the received request for a handover to the S-MeNB. The acknowledgement may comprise e.g. information about a configuration of a connection between the UE and the T-MeNB, i.e. related to the Master Cell Group, MCG, and/or information about changes to the connection between the UE and the SeNB, i.e. related to the Secondary Cell Group, SCG. The information related to the cell group(s) is to be provided, e.g. forwarded, to the UE by the S-MeNB.

The method illustrated in FIG. 3 may further comprise triggering 304 a release of the old signaling association between the S-MeNB and SeNB, since this is no longer to be used after the handover.

FIG. 4 illustrates an exemplifying method embodiment to be performed by a S-MeNB (denoted “second network node” in the appended claims). The method is related to inter-MeNB handover of a wireless device in Dual Connectivity, without change of SeNB. The method illustrated in FIG. 4 comprises requesting 401 a handover of a UE in Dual Connectivity from the S-MeNB to a T-MeNB (denoted “first network node” in the appended claims). The request is conveyed from the S-MeNB to the T-MeNB, and comprises information about the existing UE Context at the SeNB (denoted “third network node” in the appended claims) of the UE. The method illustrated in FIG. 4 further comprises receiving 402, from the T-MeNB, an acknowledgement of the request, indicating that a signaling connection has been established between the T-MeNB and the SeNB, based on the information about the UE Context. The method further comprises indicating 403, to the SeNB, a release of a signaling connection between the SeNB and the S-MeNB.

The information about the UE Context of the UE may have the same characteristics as described above, in association with FIG. 3. Further, the acknowledgement of the request may comprise information about MCG and/or SCG, i.e. cell group, configuration(s) to be provided to the UE, as described above in association with FIG. 3.

Significant for the scenario of inter-MeNB handover without SeNB change is the fact that the so-called “anchor point” is moved from the S-MeNB to the T-MeNB. In order to enable the reuse of already established features related to the SeNB, information about these established features needs to be transferred between the involved MeNBs, i.e. between the S-MeNB and the T-MeNB. Situations where an inter-MeNB handover without SeNB switch is desirable may occur e.g. between MeNB coverage areas, where a SeNB area spans over a part of both MeNB coverage areas.

The embodiments described herein are developed along with a number of identified principles, which will be briefly outlined below. One such principle is that a basic X2 handover takes place from a Source MeNB to a Target MeNB. Further, it is identified that a new X2 signaling connection needs to be established from the Target MeNB to the SeNB, while a user/UE Context already exists at the SeNB; and therefore the Source MeNB will need to provide a reference to the UE context at the SeNB, e.g. an eNB UE X2AP ID, via the Target MeNB to SeNB, in order to enable reuse, or keeping, of features of the existing connection.

Further, if the Evolved-Radio Access Bearers (E-RABs) for which Dual Connectivity is applied are configured with the SCG bearer option, the T-MeNB would need to receive information about the DL Tunnel Endpoint Identifiers (TEIDs of the S1-U, as those need to be communicated within the so-called S1 Path Switch Request procedure. As the T-MeNB would receive this information during the SeNB Addition procedure on the target side, there is no need for introducing additional Information Elements (IEs) related to this.

Further, as for the SCG bearer option, the Secondary eNB key (S-KeNB) is derived from the Master eNB key (K(M)eNB), a new S-KeNB would need to be generated by the Target MeNB, derived from the K(M)eNB associated with the Target MeNB.

It is further identified that the Source MeNB may provide the Target MeNB with MCG and SCG related information within the so-called HandoverPreparationInformation.

It is expected or anticipated by the inventors, that the SeNB configuration frequently can be kept as allocated before the inter-MeNB handover. However, given changes to the MCG configuration at the Target MeNB, the SeNB might change the SCG configuration as well.

Two random access procedures may need to be performed; one for MCG, and one for SCG. Interaction between the RRC reconfiguration procedure and the random access for the MCG may work as for a normal handover, i.e. the random access would need to be successfully performed before the UE completes the reconfiguration (RRC Connection Reconfiguration procedure). This is not necessary for the random access towards the SCG.

Data forwarding may be necessary during and/or after the handover for user data stemming from MCG bearers, i.e. bearers related to the MeNB and split bearers where the MeNB decides which Packet Data Convergence Protocol (PDCP) Packet Data Units (PDUs) are provided to the UE via MeNB cell resources and which via SeNB cell resources. In one variant of split bearers PDCP PDUs are kept in the MeNB until they are acknowledged by the SeNB, in another variant buffering is not performed in the MeNB but in the SeNB, whereas in the latter variant not yet delivered data needs to be forwarded back to the source MeNB from which it was received and further to the target MeNB, as typically inter-eNB HO results in the generation of new keys for user data ciphering, although this creates a seemingly unnecessary data forwarding loop via Source/Target MeNB.

However, no data forwarding may be necessary for SCG bearers, i.e. bearers related to the SeNB, since the related user data streams do not need to be routed via the T-MeNB.

For split bearers, the SeNB may need to know when to switch to DL data arriving from the T-MeNB instead of from the S-MeNB. One possibility to resolve this would be to determine that the switch is to be made when the first DL packet arrives from the T-MeNB. This may be detected by examining the source Transport Layer Address that is sent along with the GTP-U packet. Another possibility would be to introduce a respective indication on GTP-U or X2-UP level.

In regard of path switch, the T-MeNB could trigger the so-called S1 Path Switch Request procedure, which could contain new DL TEIDs for MCG and split bearers and unchanged DL TEIDs for SCG bearers. S-GW relocation may occur during the path switch.

It is identified that the release of the old X2 UE specific signaling association between Source MeNB and SeNB may be performed via normal SeNB Release procedure and UE Context Release in order to cope with current protocol principles.

FIG. 5 illustrates a signaling between network nodes involved in the inter-MeNB handover without SeNB change-procedure according to an exemplifying embodiment. The exemplifying embodiment may comprise the following steps or actions, described and numbered with reference to the signaling illustrated in FIG. 5:

1: Handover Request: (AS-info (SCG info), source side SeNB UE X2AP ID, SeNB ID) The Handover Request message carries the HandoverPreparationInformation containing, among others, S-MeNB and SeNB related configuration information. In order to enable the T-MeNB to connect to the proper SeNB the SeNB ID and the source side SeNB UE X2AP ID are provided. New IEs (Information Elements) introduced in the Handover Request are:
source side SeNB UE X2AP ID
SeNB ID.
   2: SeNB Addition Request: (SCG-ConfigInfo, source side SeNB UE X2AP ID, new S-KeNB) &-
   3: SeNB Addition Ack: (SCG-Config, X2-U addresses for split bearer, S1-U addresses for SCG bearers, . . . . )

The SeNB Addition procedure here does not actually add SeNB resources; it basically establishes the X2 signaling connection between the T-MeNB and SeNB. In case SeNB bearers are configured with the direct S1-U bearer option, a new security context would need to be established, as security material should be derived from the T-MeNB. New IE introduced in SeNB Addition Request are:
source side SeNB UE X2AP ID

### 4: Handover Request Ack:

The T-MeNB provides MCG and SCG related configuration information transparently to the S-MeNB within the Handover Request Acknowledgment message.

5: RRC Connection Reconfiguration (HO Cmd): The S-MeNB sends the RRCConnectionReconfiguration message to the UE.

### 6: Random Access Procedure (MCG):

The UE performs a random access procedure towards the T-MeNB.

### 7: RRC Connection Reconfiguration Complete:

The UE completes the RRC connection reconfiguration procedure.

8: SeNB reconfiguration Complete:

Upon receipt of the RRCConnectionReconfigurationComplete message from the UE, the T-MeNB sends the X2 SeNB Reconfiguration Complete message to the SeNB to indicate that the configuration requested by the SeNB was applied by the UE.

### 9: Random Access Procedure (SCG):

The UE performs Random Access for MCG and SCG resources. It should be rioted that step 9 can be performed any time after step 5.

### 10: SeNB Release Request:

The S-MeNB requests the release of the UE specific signaling connection towards the SeNB. In other words, source side UE signaling association to SeNB is removed.

11-18: Path Switch and, when applicable, data forwarding:
11. SNStatus Transfer (split and MCG bearers only)
12. Data Forwarding (split and MCG bearers only)

### 13. Path Switch Request; 14. Modify Bearer Request; 15. End Marker Packet;

16. DL data;

### 17. Modify Bearer Response;

18. Path Switch Request Ack; Data forwarding addresses might have been exchanged in steps 1 and 4, in which case data forwarding could start earlier as shown above. Path switch could be triggered after random access for MCG has been performed. The exact timing is implementation specific, as for X2 handover.

### 19-20: UE Context Release:

The T-MeNB releases the X2 signaling connection towards the S-MeNB, as for any normal X2 handover. After that the S-MeNB sends the final UE Context Release to the SeNB, which, however, only finally releases the X2 signalling connection, not the whole UE Context of the UE.

The mechanism described above enables the target MeNB to address the already established UE context at the SeNB. The UE context consists of E-UTRAN and E-UTRA signaling and user plane resources and can be addressed by means of indicating the identity of UE associated X2 signaling connection established between the Source MeNB and the SeNB towards the Target MeNB which passes it to the SeNB.

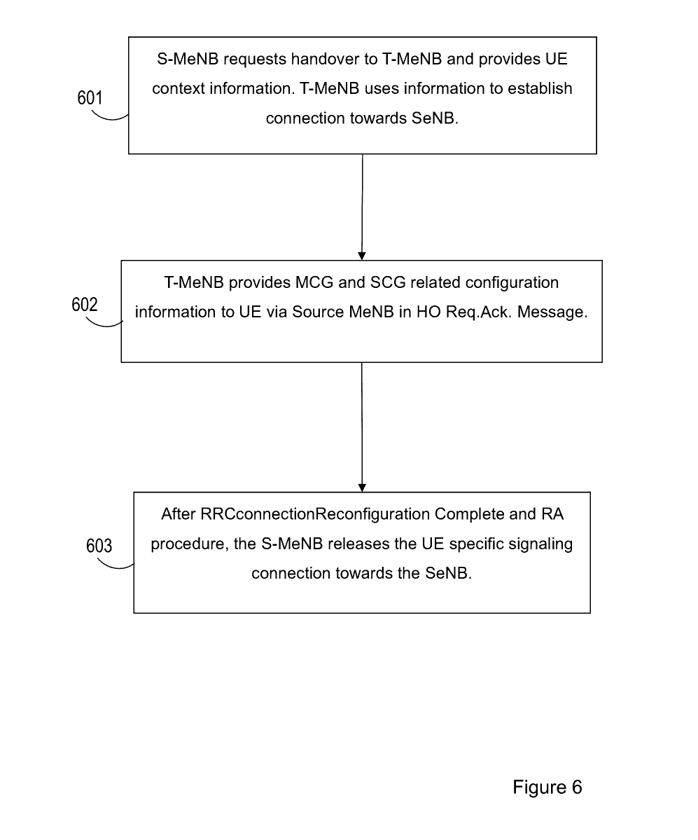

An exemplifying embodiment is illustrated in FIG. 6. Here, the method is described on a system level, i.e. the actions of many different nodes are described. It should be noted that the exemplifying method could also be described from the perspective of each individual node. The method illustrated in FIG. 6 comprises 601 that a S-MeNB requests handover to T-MeNB and provides UE context information from the SeNB to enable the T-MeNB to connect to UE context at the SeNB (SeNB ID and Source Side SeNB UE X2AP ID are defined). T-MeNB may use SeNB addition to establish the X2 signaling connection towards the SeNB. The method could further comprise 602 that the T-MeNB provides MCG and/or SCG related configuration information transparently to the UE via Source MeNB within a Handover Request Acknowledge Message. The MeNB may cause the SeNB to re-configure SCG resources, e.g. if the T-MeNB indicates a different split of UE capabilities between MCG and SCG resources than the S-MeNB)

The method illustrated in FIG. 6 further comprises 603 that the Source MeNB releases the UE specific signaling connection towards the SeNB after RRCconnectionReconfiguration Complete and Random Access procedure. No Path Switch and Data Forwarding may be necessary for E-RABs configured with the SCG bearer option. Data forwarding may need to be performed for E-RABs configured with the split bearer option.

The methods and techniques described above may be implemented in network nodes. Above, in association with describing the method embodiments, it is exemplified in which nodes in an LTE system the methods are intended to be implemented. Corresponding nodes in other communication systems may be denoted differently.

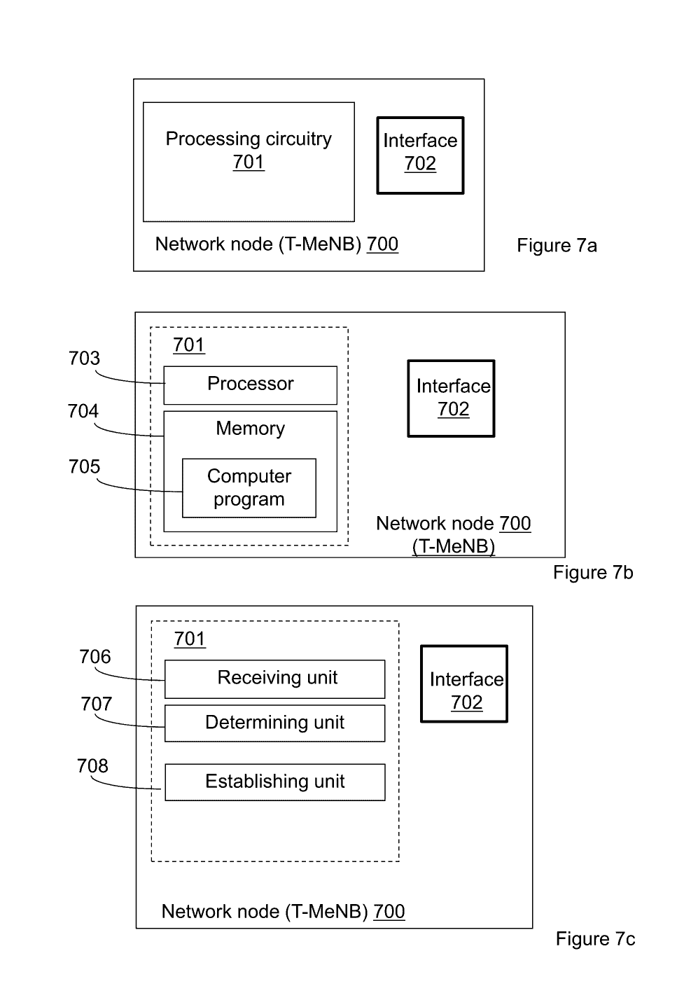

An exemplifying embodiment of a first network node, such as an eNB operable to act as a MeNB towards a wireless device, as described above, is illustrated in a general manner in FIG. 7a. The first network node 700 is operable to be a T-MeNB for a UE in Dual Connectivity, e.g. in accordance with what is described above. The first network node 700 is configured to perform at least one of the method embodiments described above with reference to any of FIG. 3, 5 or 6. The first network node 700 may be assumed to be associated with the same technical features, objects and advantages as the previously described method embodiments. The first network node will be described in brief in order to avoid unnecessary repetition, and will be denoted T-MeNB below in order to facilitate understanding.

The T-MeNB may be implemented and/or described as follows: The T-MeNB 700 may comprise processing circuitry 701 and a communication interface 702. The processing circuitry 701 is configured to cause the T-MeNB 700 to receive a request for handover of a UE in Dual Connectivity from a S-MeNB to the T-MeNB, where the request comprises information about the UE Context of the UE at a SeNB. The processing circuitry 701 is further configured to cause the T-MeNB 700 to establish a signaling connection with the SeNB based on the information about the UE Context of the UE at the SeNB. The communication interface 702, which may also be denoted e.g. Input/Output (I/O) interface, may include a network interface for sending data to and receiving data from other network nodes.

The processing circuitry 701 could, as illustrated in FIG. 7b, comprise processing means, such as a processor 703, e.g. a CPU, and a memory 704 for storing or holding instructions. The memory would then comprise instructions, e.g. in form of a computer program 705, which when executed by the processing means 703 causes the MME 700 to perform any of the actions described above.

An example of implementation of the processing circuitry 701 is shown in FIG. 7c. The processing circuitry here comprises functional units, such as a receiving unit 706, configured to cause the network node to receive a request for handover, of a UE in Dual Connectivity, from a S-MeNB to the T-MeNB, where the request comprises information about the UE Context of the UE at a SeNB. The processing circuitry further comprises an establishing unit 708, configured to cause the network node to establish a signaling connection with the SeNB based on the information about the UE Context of the UE at the SeNB. The processing circuitry may further comprise e.g. a determining unit 707, configured to cause the T-MeNB to determine or identify the received information, and take action in accordance with the received information, and/or in response to the received information. The units 706-708 are here illustrated as different units, but could alternatively be one unit configured for these tasks. The processing circuitry could comprise more units; and actions or tasks could alternatively be performed by one of the other units.

The network nodes described above could be configured for the different method embodiments described herein. The network node 700 may be assumed to comprise further functionality, for carrying out regular node functions.

Thus, the first network node, T-MeNB, 700 is operable to take part in an inter-MeNB handover of a UE in Dual Connectivity without change of SeNB

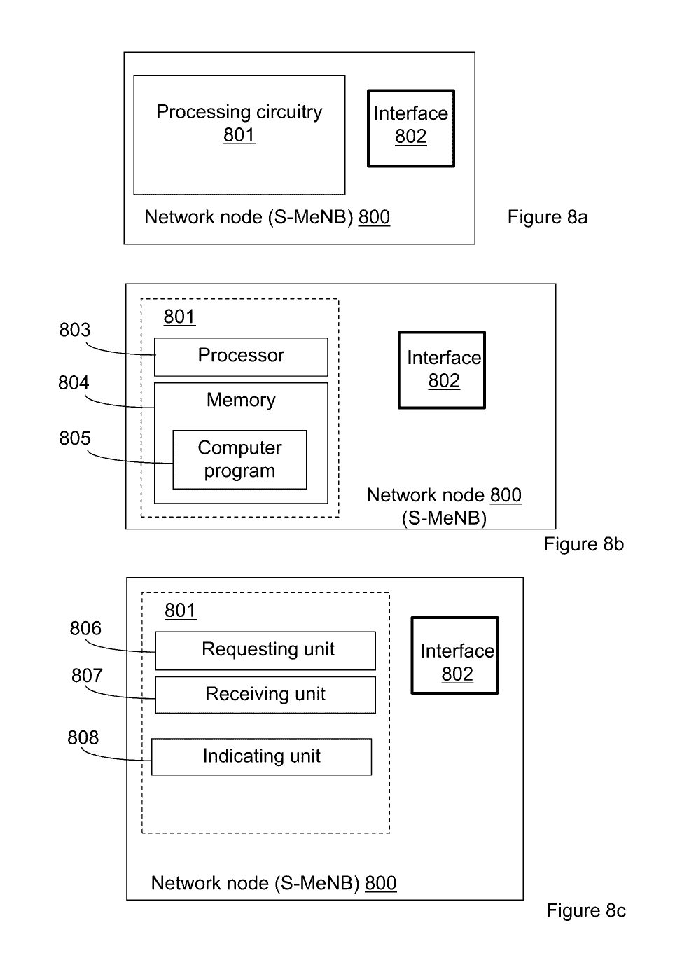

An exemplifying embodiment of a second network node, such as an eNB operable to act as a MeNB towards a wireless device, as described above, is illustrated in a general manner in FIG. 8a. The second network node 800 is operable to be a S-MeNB. The second network node 800 is configured to perform at least one of the method embodiments described above with reference to any of FIGS. 4-6. The second network node 800 may be assumed to be associated with the same technical features, objects and advantages as the previously described method embodiments. The second network node will be described in brief in order to avoid unnecessary repetition, and will be denoted S-MeNB below in order to facilitate understanding.

The S-MeNB may be implemented and/or described as follows:

The S-MeNB 800 may comprise processing circuitry 801 and a communication interface 802. The processing circuitry 801 is configured to cause the S-MeNB 800 to request a handover of a UE in Dual Connectivity to a T-MeNB, e.g. by transmitting a request message. The request comprises information about the UE Context at a SeNB associated with the UE. The processing circuitry 801 is further configured to cause the S-MeNB 800 to receive, from the T-MeNB, an acknowledgement of the request, indicating that a signaling connection has been established between the T-MeNB and the SeNB based on the information about the UE Context. The processing circuitry 801 is further configured to cause the S-MeNB 800 to indicate, to the SeNB, a release of a signaling connection between the SeNB and the S-MeNB. The communication interface 802, which may also be denoted e.g. Input/Output (I/O) interface, may include a network interface for sending data to and receiving data from other network nodes.

The processing circuitry 801 could, as illustrated in FIG. 8b, comprise processing means, such as a processor 803, e.g. a CPU, and a memory 804 for storing or holding instructions. The memory would then comprise instructions, e.g. in form of a computer program 805, which when executed by the processing means 803 causes the MME 800 to perform any of the actions described above.

An example of implementation of the processing circuitry 801 is shown in FIG. 8c. The processing circuitry here comprises functional units, such as a requesting unit 806, configured to cause the network node to request a handover of a UE in Dual Connectivity to a T-MeNB, where the request comprises information about the UE Context at a SeNB associated with the UE. The processing circuitry further comprises a receiving unit 807, configured to cause the network node to receive, from the T-MeNB, an acknowledgement of the request, indicating that a signaling connection has been established between the T-MeNB and the SeNB based on the information about the UE Context. The processing circuitry further comprises an indicating unit 808, configured to cause the network node to indicate, to the SeNB, a release of a signaling connection between the SeNB and the S-MeNB.

The units 806-808 are here illustrated as different units, but could alternatively be one unit configured for these tasks. The processing circuitry could comprise more units; and actions or tasks could alternatively be performed by one of the other units.

The network nodes described above could be configured for the different method embodiments described herein. The network node 800 may be assumed to comprise further functionality, for carrying out regular node functions.

Thus, the second network node, S-MeNB, 800 is operable to take part in an inter-MeNB handover of a UE in Dual Connectivity without change of SeNB.

The network nodes may be implemented in a distributed manner, e.g. where part of the actions are each performed at different nodes or entities e.g. at different locations in the network. For example, one or more embodiments could be implemented in a so-called cloud solution. The distributed case could be referred to or described as that the method is performed by an arrangement or a network node operable in the communication network, but that the arrangement or the network node could be distributed in the network, and not necessarily be comprised in a physical unit.

The steps, functions, procedures, modules, units and/or blocks described herein may be implemented in hardware using any conventional technology, such as discrete circuit or integrated circuit technology, including both general-purpose electronic circuitry and application-specific circuitry.

Particular examples include one or more suitably configured digital signal processors and other known electronic circuits, e.g. discrete logic gates interconnected to perform a specialized function, or Application Specific Integrated Circuits (ASICs).

Further, at least some of the steps, functions, procedures, modules, units and/or blocks described above may be implemented in software such as a computer program for execution by suitable processing circuitry including one or more processing units. The software could be carried by a carrier, such as an electronic signal, an optical signal, a radio signal, or a computer readable storage medium before and/or during the use of the computer program in the network nodes.

The flow diagram or diagrams presented herein may be regarded as a computer flow diagram or diagrams, when performed by one or more processors. A corresponding apparatus may be defined as a group of function modules, where each step performed by the processor corresponds to a function module. In this case, the function modules are implemented as a computer program running on the processor.

Examples of processing circuitry includes, but is not limited to, one or more microprocessors, one or more Digital Signal Processors, DSPs, one or more Central Processing Units, CPUs, and/or any suitable programmable logic circuitry such as one or more Field Programmable Gate Arrays, FPGAs, or one or more Programmable Logic Controllers, PLCs. That is, the units or modules in the arrangements in the different nodes described above could be implemented by a combination of analog and digital circuits, and/or one or more processors configured with software and/or firmware, e.g. stored in a memory. One or more of these processors, as well as the other digital hardware, may be included in a single application-specific integrated circuitry, ASIC, or several processors and various digital hardware may be distributed among several separate components, whether individually packaged or assembled into a system-on-a-chip, SoC.

It should also be understood that it may be possible to re-use the general processing capabilities of any conventional device or unit in which the proposed technology is implemented. It may also be possible to re-use existing software, e.g. by reprogramming of the existing software or by adding new software components.

The embodiments described above are merely given as examples, and it should be understood that the proposed technology is not limited thereto. It will be understood by those skilled in the art that various modifications, combinations and changes may be made to the embodiments without departing from the present scope. In particular, different part solutions in the different embodiments can be combined in other configurations, where technically possible.

When using the word “comprise” or “comprising” it shall be interpreted as non-limiting, i.e. meaning “consist at least of”.

It should also be noted that in some alternate implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved. Moreover, the functionality of a given block of the flowcharts and/or block diagrams may be separated into multiple blocks and/or the functionality of two or more blocks of the flowcharts and/or block diagrams may be at least partially integrated. Finally, other blocks may be added/inserted between the blocks that are illustrated, and/or blocks/operations may be omitted without departing from the scope of inventive concepts.

It is to be understood that the choice of interacting units, as well as the naming of the units within this disclosure are only for exemplifying purpose, and nodes suitable to execute any of the methods described above may be configured in a plurality of alternative ways in order to be able to execute the suggested procedure actions.

It should also be noted that the units described in this disclosure are to be regarded as logical entities and not with necessity as separate physical entities.

### ABBREVIATIONS

### 3GPP 3rd Generation Partnership Project

### E-UTRAN Evolved UMTS Terrestrial Radio Access Network

eNB/eNodeB enhanced Node B (base station)

### HeNB Home eNB

### HO Handover

### IE Information Element

### LTE Long Term Evolution

### MeNB Master eNB

### MCG Master Cell Group

### SeNB Secondary eNB

### SCG Secondary Cell Group

### S-MeNB Source MeNB

### SCG Secondary Cell Group

### T-MeNB Target MeNB

### UE User Equipment

1-16. (canceled)

17. A method performed by a first network node, the method comprising:
receiving a request for handover of a User Equipment (UE) in Dual Connectivity from a second network node to the first network node, the request comprising information about the UE Context of the UE at a third network node, the first network node being a Target Master eNB (T-MeNB) for the UE, the second network node being a Source Master eNB (S-MeNB) for the UE, and the third network node being a Secondary eNB (SeNB) for the UE; and
establishing a signaling connection with the third network node based on the information about the UE Context;
the method relating to inter-MeNB handover without SeNB change.

18. The method according to claim 17, wherein the information about the UE Context of the UE at the third network node comprises an identifier of the third network node, and an identifier of a signaling connection established between the second network node and the third network node.

19. The method according to claim 17, wherein establishing the signaling connection comprises sending a SeNB Addition Request to the third network node comprising the received information about a UE Context, and further receiving a SeNB Addition Acknowledgement from the third network node in response to the request.

20. The method according to claim 17, further comprising:
providing an acknowledgement of the request for a handover to the second network node, the acknowledgement comprising information about a Cell Group configuration, to be provided to the UE.

21. A method performed by a second network node, the method comprising:
requesting a handover of a User Equipment (UE) in Dual Connectivity from the second network node to a first network node, the request comprising information about the UE Context of the UE at a third network node, the second network node being a Source Master eNB (S-MeNB) for the UE, the first network node being a Target Master eNB (T-MeNB) for the UE, and the third network node being a Secondary eNB (SeNB) for the UE;
receiving, from the first network node, an acknowledgement of the request, indicating that a signaling connection has been established between the first network node and the third network node based on the information about the UE Context; and
indicating, to the third network node, a release of a signaling connection between the third network node and the second network node;
the method relating to inter-MeNB handover without SeNB change.

22. The method according to claim 21, wherein the information about a UE Context comprises an identifier of the third network node, and an identifier of a signaling connection established between the second network node and the third network node.

23. The method according to claim 21 wherein the acknowledgement of the request further comprises information about a Cell Group configuration, to be provided to the UE.

24. A first network node operable in a wireless communication network, the first network node being configured to:
receive a request for a handover of a User Equipment (UE) in Dual Connectivity from a second network node to the first network node, the request comprising information about the UE Context of the UE at a third network node, the first network node being operable to be a Target Master eNB (T-MeNB) for the UE, the second network node being a Source Master eNB (S-MeNB) for the UE and the third network node being a Secondary eNB (SeNB) for the UE; and
establish a signaling connection with the third network node as a Secondary eNB (SeNB), based on the information about the UE Context.

25. The first network node according to claim 24, wherein the information about the UE Context comprises an identifier of the third network node, and an identifier of a signaling connection established between the second network node and the third network node.

26. The first network node according to claim 24, wherein the establishing of a signaling connection comprises to send a SeNB Addition Request to the third network node, comprising the received information about the UE Context, and further receiving a SeNB Addition Acknowledgement from third network node in response to the request.

27. The first network node according to claim 24, being further configured to:
provide an acknowledgement of the request for a handover to the second network node, the acknowledgement comprising information about a Cell Group configuration, to be provided to the UE.

28. A second network node operable in a wireless communication network, the second network node being configured to:
request a handover of a User Equipment (UE) in Dual Connectivity to a first network node, the request comprising information about a UE Context at a third network node, the second network node being operable to be a Source Master eNB (S-MeNB) for the UE, the first network node being a Target Master eNB (T-MeNB) for the UE, and the third network node being a Secondary eNB (SeNB) for the UE;
receive, from the first network node, an acknowledgement of the request, indicating that a signaling connection has been established between the first network node and the third network node based on the information about the UE Context; and
indicate, to the third network node, a release of a signaling connection between the third network node and the second network node.

29. The second network node according to claim 28, wherein the information about the UE Context comprises an identifier of the third network node, and an identifier of a signaling connection established between the second network node and the third network node.

30. The second network node according to claim 28, wherein the acknowledgement of the request further comprises information about a Cell Group configuration, to be provided to the UE.

31. A non-transitory computer-readable medium storing a computer program that, when executed by a processing circuit in a first network node operable as a Target Master eNB (T-MeNB) for a User Equipment (UE), the computer program comprising program instructions configuring the first network node to:
receiving a request for handover of a User Equipment (UE) in Dual Connectivity from a second network node to the first network node, the request comprising information about the UE Context of the UE at a third network node, the second network node being a Source Master eNB (S-MeNB) for the UE, and the third network node being a Secondary eNB (SeNB) for the UE; and
establishing a signaling connection with the third network node based on the information about the UE Context;
the method relating to inter-MeNB handover without SeNB change.
